(19) United States
(12) Patent Application Publication
(10) Pub. No.: US 2022/0323277 A1
(43) Pub. Date: Oct. 13, 2022

(54) WARMING DEVICE FOR WHEELCHAIR HANDRIM

(71) Applicants: Kathryn Greenwell, Centerville, OH (US); Leah Schulze, Westerville, OH (US)

(72) Inventors: Kathryn Greenwell, Centerville, OH (US); Leah Schulze, Westerville, OH (US)

(21) Appl. No.: 17/659,148

(22) Filed: Apr. 13, 2022

Related U.S. Application Data
(60) Provisional application No. 63/174,353, filed on Apr. 13, 2021.

(51) Int. Cl. A61G 5/02; H05B 3/42; H05B 3/00

(52) U.S. Cl. CPC A61G 5/028; H05B 3/42; H05B 3/0019

(57) ABSTRACT

A warming device for the handrim of a wheelchair is disclosed herein to relieve discomfort caused by manually wheeling a wheelchair in cold and/or wet weather conditions. The warming device includes a hand interface, a mount, and a heating element. The warming device is configured to mount the tube of a handrim. The heating element of the warming device is coupled to an electronics system including a printed circuit board and a battery. The electronics system may be internal to the warming device, or may be housed in an external electronics box mounted similarly to the handrim or the rear wheel of the wheelchair.

This application claims the benefit of United States Provisional Patent Application No. 63/174,353, filed on Apr. 13, 2021. The entire disclosure of the above application is hereby incorporated herein by reference.

### FIELD

The present invention relates a warming device, and more particularly a warming device for warming the handrim, or push rim, of a wheelchair.

### BACKGROUND OF THE INVENTION

As known, manual wheelchairs are chairs fitted with wheels for use as a means of transport by a person who is unable to walk as a result of illness, injury, or disability. The wheel chairs include a pair of rear wheels and a handrim, or push rim, coupled to each of the rear wheels. The handrims are used, by the hands of a user, to control and rotate the rear wheels to push or move, i.e. “wheel,” the wheelchair in the direction desired.

The way most wheelchairs are configured, most push rims are made of aluminum, which becomes incredibly cold and slippery during times of inclement weather. The current solutions, such as gloves and handwarmers, are not viable, as they make wheeling the user difficult.

When manual wheelchair users are wheeling themselves through cold, rain, or snow, it can be painful, difficult, and dangerous. Holding on to cold metal while being unable to shield their hands from the cold temperatures means many wheelchair users often must deal with their hands going numb when they are outside. Additionally, rims often get slippery if a wheelchair user is outside in the rain or snow, and this can become dangerous, as it makes it much harder to stop or slow themselves down.

To solve this issue, many wheelchair users may use gloves or hand warmers. However, gloves make wheeling more difficult. Additionally, thick gloves can have a tendency to get caught in the spokes or other components of the wheelchair. Thin gloves still do not resolve the problem of coldness and wetness. Furthermore, gloves prevent desired gripping of the push rims to properly push or stop the wheelchair. Hand warmers are undesired because a user must hold the hand warmers in their hand while also trying to push the wheelchair. Another solution to the problem are rim covers. Rim covers cover the push rims and may provide a “grip” but do not solve the issue of cold hands. It is also desired to not overcomplicate how a wheelchair is operated or augment or supplement the wheelchair in a way that would be cumbersome, uncomfortable, unsafe, interfere with wheelchair requirements or guidelines, make the wheelchair more difficult to push than necessary, or expensive.

Therefore, there is a need for a device for warming the push rim of the manual wheelchairs that is ergonomic and simple and does not interfere with an efficient and safe operation of the wheelchair by a user.

### BRIEF SUMMARY

In accordance and attuned with the present invention, a warming device for the handrim of a manual wheelchair that is ergonomic, simple, and does not interfere with the efficient and safer operation of the wheelchair by a user, has been developed.

In one aspect, a warming device for a wheelchair handrim is disclosed. The warming device comprising a hand interface, a mount configured to mount to the handrim of a wheelchair, and a heating element. In some embodiments, the warming device further comprises an internal frame with the heating element, at least one printed circuit board and at least one battery mounted thereto. In other embodiments, the heating element is coupled to an external electronics box. In some embodiments, the external electronics box contains at least one circuit board and at least one battery. Additionally, in some embodiments the external electronics box may contain a charging port, a power button, and/or an indicator light.

In another aspect, a warming device for a wheelchair handrim is disclosed. The warming device comprising a hand interface, a mount configured to mount to the handrim of a wheelchair, an internal plastic frame, a heating element coupled to the internal plastic frame, at least one circuit board, and at least one battery coupled to the internal plastic frame. In some embodiments, the warming device may further include a charging port, a power button, and/or an indicator light.

In some embodiments, the hand interface of the warming device may comprise tread to increase the user's grip on the device.

In some embodiments, the warming device is configured to mount to about a third of the handrim of the wheelchair. In other embodiments, the warming device is configured to mount to about a quarter of the handrim of the wheelchair.

In some embodiments, the warming device includes of a material with a shore hardness of 40. In some embodiments, the warming device includes thermoplastic polyurethane material.

In some embodiments, the mount of the warming device includes a semi-circular cavity configured to envelop, at least partially, the tube of the handrim. Additionally, or alternatively, the mount may include a means of attachment including a hook and loop fastener strap, a tie-strap, and a palm press clamp.

The features, functions, and advantages that have been discussed may be achieved independently in various embodiments of the present disclosure or may be combined in yet other embodiments, further details of which can be seen with reference to the following description and drawings.

### BRIEF DESCRIPTION OF THE DRAWINGS

Example embodiments of the invention are described in greater detail below on the basis of the figures. These show, to some extent in highly simplified representations:

FIG. 1A is a perspective view of a common manual wheelchair;

FIGS. 1B and 1C are perspective views of a common manual wheelchair affixed with the warming device, in accordance with an embodiment of the present disclosure;

FIG. 2A and FIG. 2B are fragmentary perspective views of a warming device mounted to a handrim, in accordance with an embodiment of the present disclosure;

FIG. 3A is a first side perspective view of a warming device, in accordance with an embodiment of the present disclosure;

FIG. 3B is a second side perspective view of a warming device, in accordance with an embodiment of the present disclosure;

FIGS. 4A and 4B are exploded perspective views of a warming device, in accordance with an embodiment of the present disclosure;

FIG. 5 is a sectional view of a warming device, in accordance with an embodiment of the present disclosure; and

FIGS. 6A-6C are fragmentary perspective views of a user mounting the warming device to a handrim, in accordance with an embodiment of the present disclosure.

### DETAILED DESCRIPTION OF EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

As used herein, substantially is defined as “to a considerable degree” or “proximate” or as otherwise understood by one ordinarily skilled in the art. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters. Where any conflict or ambiguity may exist between a document incorporated by reference and this detailed description, the present detailed description controls. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to manual wheelchairs and specifically to a warming device for the push rim of the rear wheels of the wheelchair configured to warm the hand of a user while wheeling the wheelchair. However, it is understood, the technology can be employed in automatic wheelchairs, other push rim type components used for other systems, devices, or operations if desired.

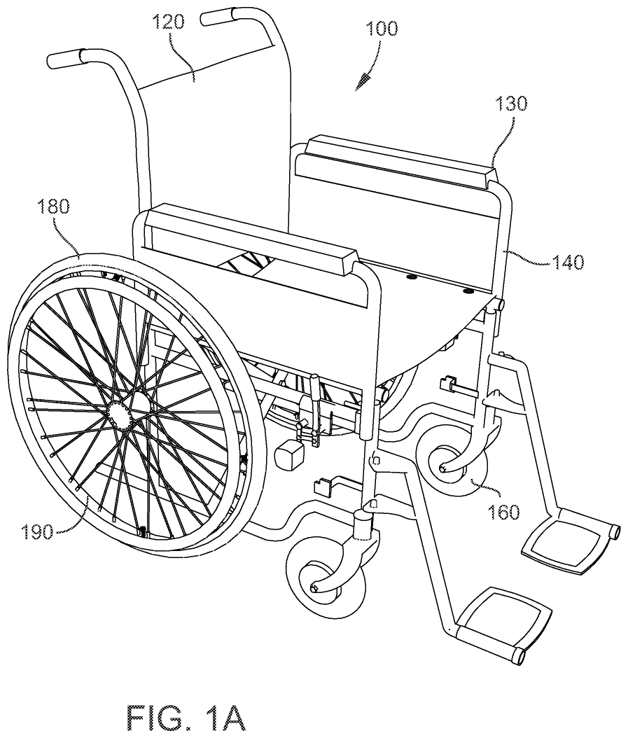

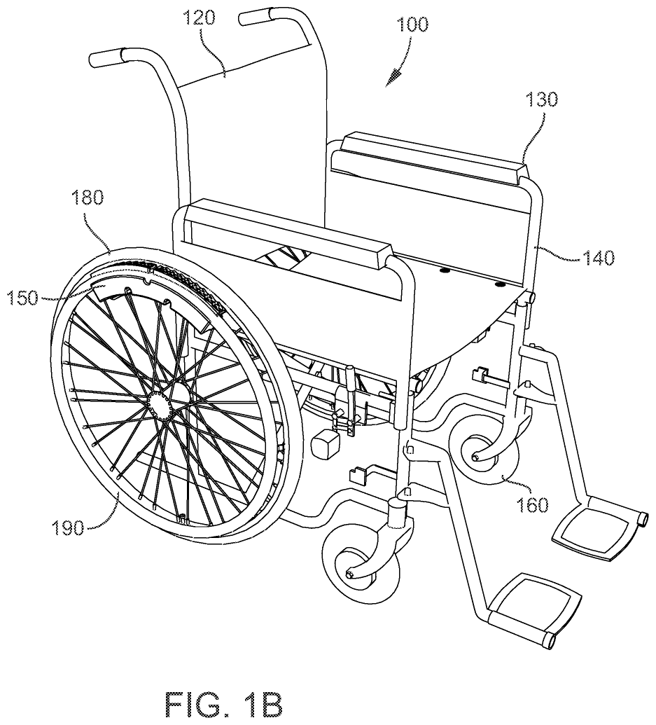

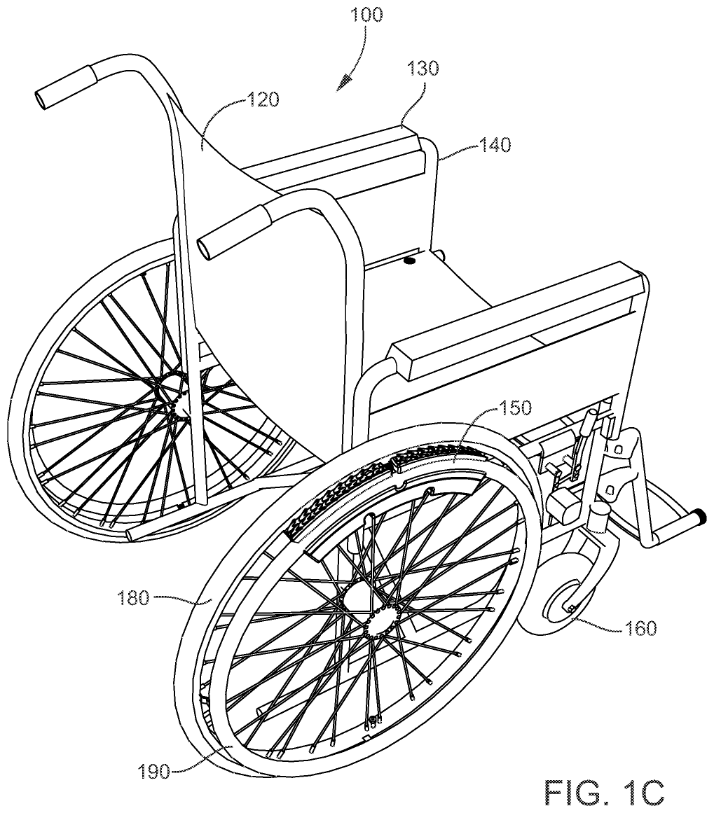

FIG. 1A illustrates a wheelchair 100 according to an embodiment of the disclosure. The wheelchair 100 includes a chair 120 with hand rests 130 supported within a frame 140. A pair of front caster wheels 160 is coupled to the frame 140 adjacent a front of the chair 120. A pair of rear wheels 180 is coupled to the frame 140 adjacent a rear of the chair 120. The rear wheels 180 have a diameter larger than the caster wheels 160, wherein a user of the wheelchair 100 can reach over the hand rests 130 to reach the rear wheels 180. A handrim, or push rim, 190 is coupled to each of the rear wheels 180. As such, the handrim 190 is concentric with each of the rear wheels 180. The handrim 190 is spaced axially outwardly, with respect of the chair 120, from the respective one of the rear wheels 180. The handrims 190 are annular and are configured to be gripped by hands of the user. Once gripped, the user applies a force in a first rotational direction to rotate the handrim 190 which concurrently rotates the rear wheels 180 causing the wheelchair 100 to move forward. Upon a force in a second rotational direction, a momentum of the wheelchair 100 is slowed or stopped. The handrim 190 is formed from a metal such as aluminum. However, the handrim can be formed from any metal or any material as is commonly used for use in the manufacture of wheelchairs. FIG. 1B illustrates a wheelchair 100 affixed with the warming device 150 of the present disclosure. The warming device 150 is mounted to the handrim 190 of the wheelchair 100. FIG. 1C illustrates a second view of the wheelchair 100 affixed with the warming device 150. The warming device 150 described in the present disclosure is configured to receive a range of handrim sizes. Common handrim sizes include: 22 inch diameter and 24 inch diameter. Additionally, the size of the handrim tube may vary as well. Common handrim tube sizes include diameters ranging from about 0.75 inch to 1.5 inches.

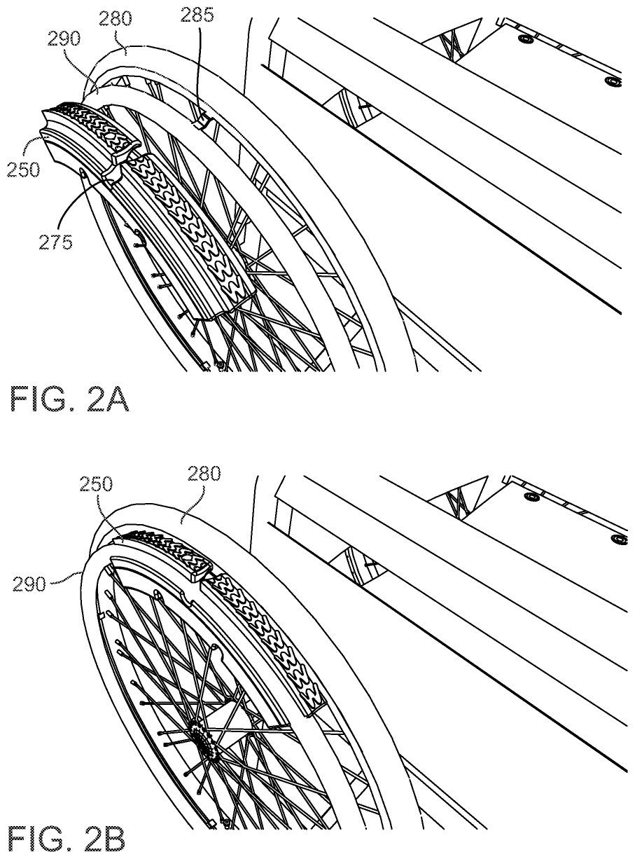

FIG. 2A and FIG. 2B illustrate how the warming device 250 mounts the handrim 290, in accordance with an embodiment of the present disclosure. As seen in FIG. 2A, there are multiple brackets 285 connecting the handrim 290 to the rear wheel 280. The warming device 250 is configured with a gap 275 to fit around a bracket 285 and mount to the handrim 290.

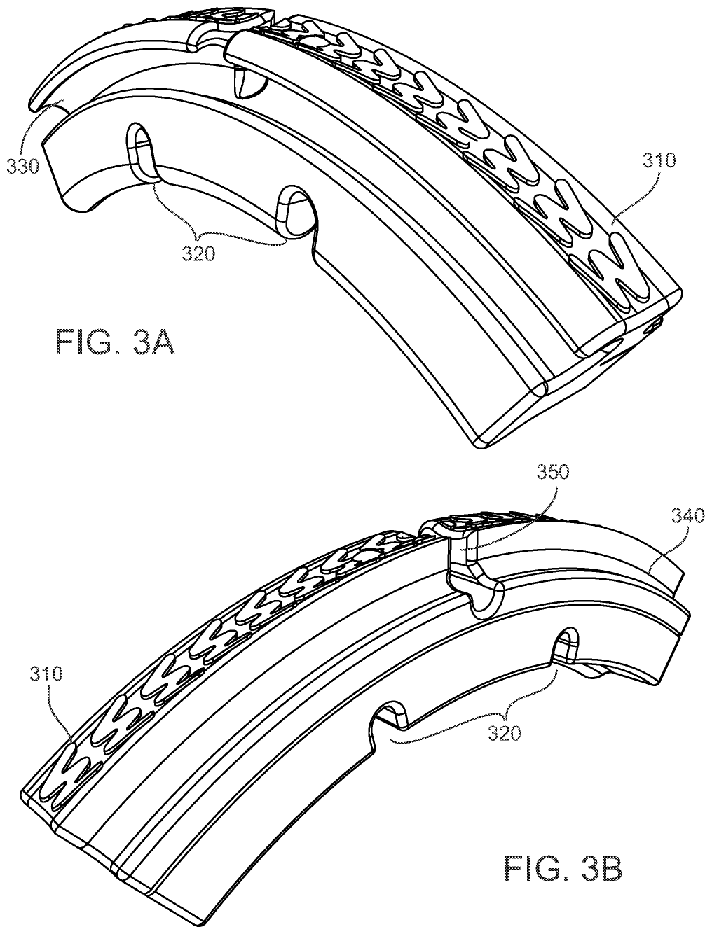

FIG. 3A represents a first-side view of the warming device 250. In the illustrated embodiment, the warming device 250 includes a semi-circular cavity 330 configured to mount, or partially envelop, the tube of the handrim 290. FIG. 3B represents a second side view of the warming device 250. In the illustrated embodiment, the warming device 250 includes an irregularly-shaped cavity 340 to accommodate for the rear wheel 280. Additionally, in the illustrated embodiment of the warming device 250, the device includes notches 320 to allow the warming device 250 to flex during installation and to accommodate a range of handrim diameters and tube sizes. Further, this embodiment includes a gap 350 configured to fit around a bracket mounting the handrim 290 to the rear wheel 280. The warming device 250 also includes a hand interface 310. The hand interface 310 may be texturized, or have tread, to improve the grip a user has on the warming device 250.

The warming device 250 may be mounted to the handrim 290 in various ways. In some embodiments, the warming device 250 is mounted to the handrim 290 via a loop on the warming device 250 using a strap, or straps comprised of hook and loop fastener. Additionally, or alternatively, the warming device 250 may be mounted to the handrim 290 using at least one palm press clamp. In some embodiments, the warming device 250 may be mounted to the handrim 290 via a loop on the warming device using a tie strap, or straps. In an embodiment, the warming device 250 is mounted to the handrim 290 by providing increased friction to the surface of the semi-circular cavity 330 to increase the warming devices grip on the tube of the handrim 290. Increased friction may be an inherent property of the material used to manufacture the warming device 250. The gaps 350 fit around the brackets 285 and further prevent the warming device 250 from sliding around the handrim 290 as well as add additional friction and grip for mounting the handrim 290.

The warming device 250 may be mounted to the entire circumference of the handrim 290. In some embodiments, the warming device 250 may be mounted to about a half of the circumference of the handrim 290. In other embodiments, the warming device 250 may be mounted to about a quarter of circumference of the handrim 290. In still further embodiments, the warming device 250 may be mounted to about a third of the circumference of the handrim 290. Advantages of the device only mounting a portion of the handrim 290 include ease of installation by the user. Frequently, when a user is advancing the wheelchair, they grab the handrim 290 to push about once every rotation of the wheel, therefore the device may not be required to cover the entire circumference of the handrim 290.

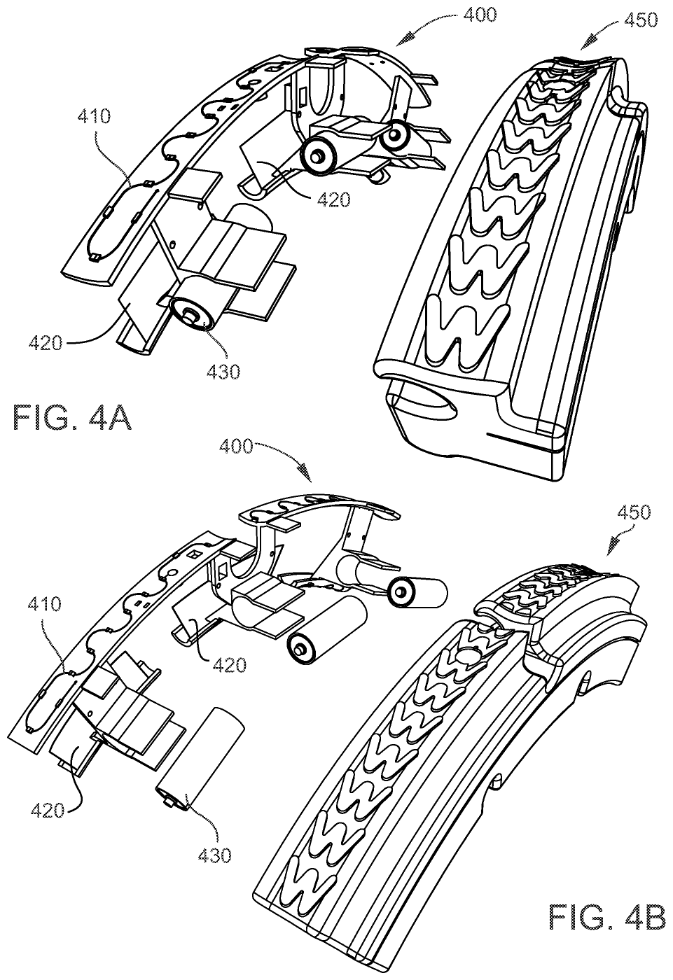

The warming device 250 comprises electronic components configured to provide heat to the device, as represented in the dissected views FIGS. 4A and 4B. The warming 250 device includes an internal frame 400 inside a flexible exoskeleton 450. Heat is generated using a heating element 410 that converts electrical energy into thermal or heat energy. In some embodiments, the heating element 410 is a resistance wire. In some embodiments, the resistance wire is nichrome. In other embodiments, the resistance wire is kanthal. Additionally, or alternatively, the resistance wire is cupronickel. Other heating elements are also possible, such as ceramic and semiconductor heating elements, as well as thick film heaters printed on a thin substrate, for example. Polymer PTC heating elements are another potential heating element suitable for the warming device of the present disclosure.

The heating element 410 needs an electrical energy source to convert electrical energy into thermal energy. In some embodiments, the energy source is a battery, or batteries 430. In some embodiments, the batteries are rechargeable. Additionally, or alternatively, the warming device may have a charging port for charging the battery, or batteries. In some embodiments, the batteries are not rechargeable and thus require replacing. In some embodiments, the warming device will include a door to access a battery cabinet. In another embodiment, the warming device comprises three 4-Volt batteries in series. However, it should be understood by one of ordinary skill in the art that any other battery arrangement may be suitable. The warming device 250 may comprise at least one printed circuit board 420 for controlling current to the heating element 410. In some embodiments, the warming device 250 comprises two printed circuit boards; one circuit board for controlling current to the heating element and a second circuit board for controlling battery charging.

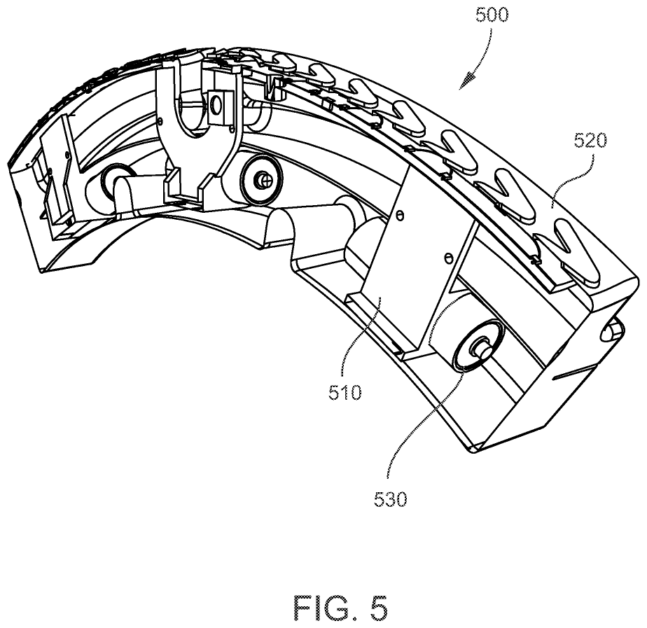

A sectional view of a warming device 500 in accordance with another embodiment, is represented in FIG. 5. A flexible exoskeleton 520 houses an internal frame 510 and its electrical components, as mentioned above. In some embodiments, the electrical component include a battery, or batteries, 530.

The warming device 500 may further include a power button or other control device. In some embodiments, the warming device 500 may include a button or other control device to control a temperature level. The warming device 500 may further include at least one indicator light. In some embodiments, the indicator light indicates that the warming device 500 is on. Additionally, or alternatively, the indicator light may indicate that the batteries are charging. In some embodiments, the indicator light may indicate that the battery, or batteries, require charging.

In another embodiment, not shown in the drawings, the electronic components are stored in an electronics box external to the warming device. In this embodiment, the heating element is connected to the external electronics box. The external electronics box contains at least one printed circuit board and at least one battery. In some embodiments, the external electronics box may also contain a charging port to charge the at least one battery. Additionally, or alternatively, the external electronics box may also contain a power button or other controller. The power button may simply switch the power on and off, however in some embodiments the power button may also allow the user to choose a temperature for the warming device. In some embodiments, the external electronics box may further contain an indicator light. The indicator light may indicate that the power is on. The external electronics box may be configured to mount to the handrim of the wheelchair. The external electronics box may also be configured to mount to the rear wheel of the wheelchair.

The warming device should be easily mountable to the handrim. More specifically, it should be easy to mount to the handrim with minimal dexterity, and in some cases with one hand. Application of the warming device should require minimal effort from the user, as in many instances, the user will be applying the device to the handrim while sitting in the manual wheelchair. For these reasons, the warming device is flexible. In some embodiments, the warming device is comprised of a material with a shore hardness of 40. Additionally, or alternatively, the warming device may be made of material with a shore hardness of 30. Other shore hardness levels may be used for the warming device that provide the warming device with the flexibility to mount the handrim along with the durability to protect any internal components. The warming device may be comprised of a synthetic polymer with the appropriate hardness, or durability. In some embodiments, the warming device is made of a thermoplastic polyurethane.

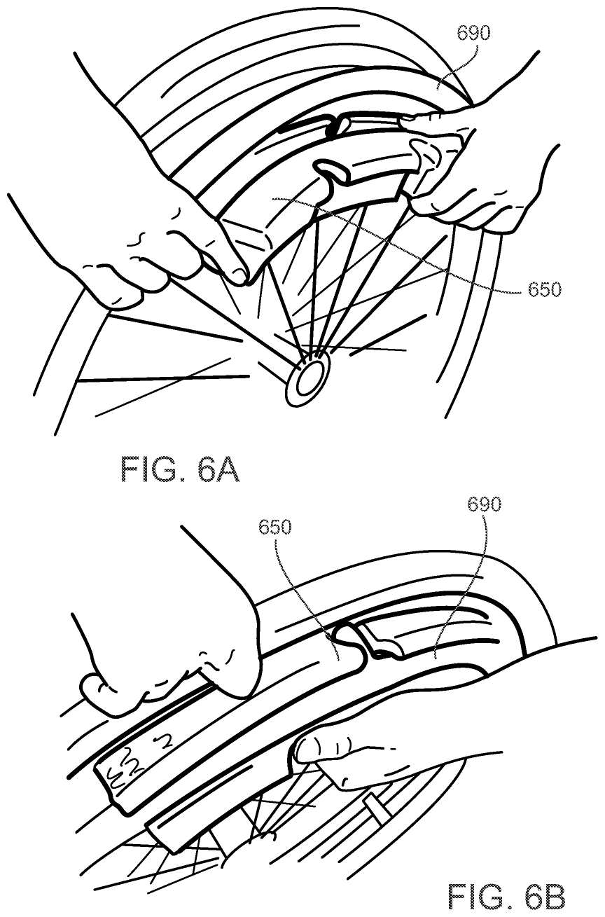

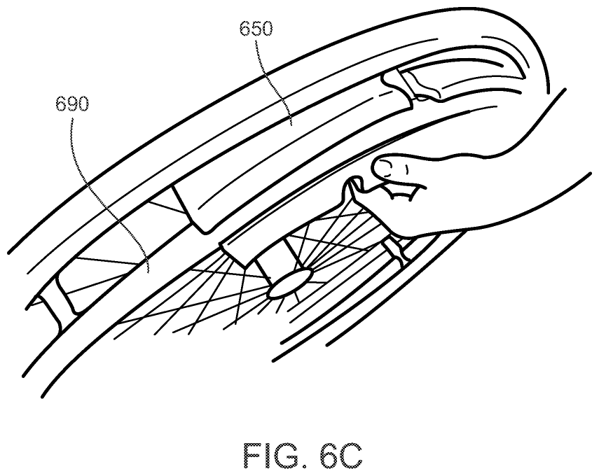

FIGS. 6A-6C represent the steps of mounting the warming device 650 to a handrim 690 of a manual wheelchair. The semi-circular cavity of the warming device 650 is aligned with the bottom of the handrim 690, as seen in FIG. 6A. The warming device 650 may then be pushed up and around the handrim 690 while aligning the gap of the warming device 650 with the bracket of the handrim 690 as seen in FIG. 6B. And finally, the warming device 650 is adjusted and secured on the handrim 690, as seen in FIG. 6C.

In one embodiment, the flexible exoskeleton of the warming device 650 may be manufactured using a 3D printed mold. The internal frame may also be manufactured using 3D printing from a synthetic plastic, resin, carbon fiber, or any other suitable material. The electronic components, such as the printed circuit board, battery (or batteries), and resistance wire are mounted to the internal frame. The internal frame is placed into the 3D printed mold and the mold is filled with a synthetic polymer, such as a thermoplastic polyurethane. Dyes may be added to the synthetic polymer to provide warming devices of different colors. Additionally, coatings may be added to the surface of the warming device 650. In some embodiments, a UV-resistant coating is added to the surface to prevent sun damage and fading of the warming device 650.

The present disclosure solves the problem introduced in the background of this specification, cold and pain caused by wheeling a manual wheelchair in during cold and/or wet weather by presenting a warming device 650 for the handrim of a wheelchair. Optimally, the warming device 650 will not additional width to the wheelchair, as it is already often difficult to pass through narrow passages. Additionally, the warming device 650 will be relatively easy to mount to the handrim, particularly by a user with minimal dexterity. For these reasons, the warming device 650 presented herein mounts to the inside of a handrim tube (between the handrim and the rear wheel), and does not mount to the entire circumference of the handrim. However, it should be understood by one of ordinary skill in the art that the disclosed warming device 650 may be configured to mount to the entire circumference of the handrim, as well as mount to any portion of the handrim tube.

Particular embodiments and features have been described with reference to the accompanying drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A warming device for a wheelchair handrim comprising:
a hand interface,
a mount configured to mount to a handrim of a wheelchair, and
a heating element.

2. The warming device for a wheelchair handrim according to claim 1, further comprising an internal frame, wherein at least one printed circuit board, at least one battery, and the heating element are coupled to the internal frame.

3. The warming device for a wheelchair handrim according to claim 1, wherein the heating element is coupled to an external electronics box.

4. The warming device for a wheelchair handrim according to claim 3, wherein the external electronics box comprises:
at least one circuit board, and
at least one battery.

5. The warming device for a wheelchair handrim according to claim 4, wherein the external electronics box further comprises at least one of a charging port, a power button, and an indicator light.

6. The warming device for a wheelchair handrim according to claim 1, wherein the warming device is configured to mount to at least a quarter of the handrim.

7. The warming device for a wheelchair handrim according to claim 1, wherein the warming device is comprised of a material with a shore hardness of 40.

8. The warming device for a wheelchair handrim according to claim 1, wherein the warming device is comprised of thermoplastic polyurethane.

9. The warming device for a wheelchair handrim according to claim 1, wherein the mount comprises a semi-circular cavity to at least partially envelop a tube of the handrim.

10. The warming device for a wheelchair handrim according to claim 1, wherein the mount is one of a hook and loop fastener strap, a tie-strap, and a palm press clamp.

11. The warming device for a wheelchair handrim according to claim 1, wherein the hand interface comprises tread.

12. A warming device for a wheelchair handrim comprising:
a hand interface,
a mount configured to mount to a handrim of a wheelchair,
an internal plastic frame;
a heating element coupled to the internal plastic frame,
at least one circuit board coupled to the internal plastic frame, and
at least one battery coupled to the internal plastic frame.

13. The warming device for a wheelchair handrim according to claim 11, further comprising at least one of a charging port, a power button, and an indicator light.

14. The warming device for a wheelchair handrim according to claim 11, wherein the warming device is configured to mount at least a quarter of the handrim of the wheelchair.

15. The warming device for a wheelchair handrim according to claim 11, wherein the warming device is comprised of a material with a shore hardness of 40.

16. The warming device for a wheelchair handrim according to claim 11, wherein the warming device is comprised of a thermoplastic urethane.

17. The warming device for a wheelchair handrim according to claim 11, wherein the mount comprises a semi-circular cavity to at least partially envelop a tube of the handrim.

18. The warming device for a wheelchair handrim according to claim 11, wherein the mount is one of a hook and loop fastener strap, a tie-strap, and a palm press clamp.

19. The warming device for a wheelchair handrim according to claim 11, wherein the hand interface comprises tread.
